(19) United States
(12) Patent Application Publication
(10) Pub. No.: US 2011/0202200 A1
(43) Pub. Date: Aug. 18, 2011

(54) ENGINE STARTING APPARATUS

(75) Inventor: Masaki KOIKE, Kobe-shi (JP)

(73) Assignee: FUJITSU TEN LIMITED, Kobe-shi (JP)

(21) Appl. No.: 13/020,378

(22) Filed: Feb. 3, 2011

(30) Foreign Application Priority Data
Feb. 18, 2010 (JP) 2010-033554

(51) Int. Cl. F02N 11/08

(52) U.S. Cl. 701/2

(57) ABSTRACT

An engine starting apparatus for starting an engine that is installed in a vehicle starts the engine in response to radio signals received from a remote control. When a result of an authentication implemented after the start of the engine by an authentication part that authenticates a key code stored in a vehicle key that a user possesses is unsuccessful, the engine starting apparatus stores unsuccessful data indicating that the result of the authentication was unsuccessful in a memory part while maintaining the engine running. The engine starting apparatus stops the running of the engine when a door is opened after the start of the engine if the unsuccessful data are stored in the memory part before the start of the engine.

### BACKGROUND OF THE INVENTION

1. Field of the Invention

The invention relates to technology that starts an engine installed in a vehicle in response to radio signals received from a remote control.

2. Description of the Background Art

A remote control which accepts users' operations sends signals to instruct a start of an engine in a vehicle to a control apparatus installed in a vehicle (hereinafter referred to as a “starting apparatus”). The starting apparatus starts the engine installed in the vehicle in response to signals that are sent from the remote control (hereinafter referred to as a “starting an engine remotely”). This helps the starting apparatus to warm up the engine by the time when a user gets in the vehicle. In addition, in cold areas, a user can start the vehicle immediately after getting in the vehicle because the engine is already warmed up.

Such a remote engine starter control usually stops an engine running when a user unlocks the vehicle door.

That is because, when the starting apparatus maintains the engine running without stopping the engine running, a non-authorized user might break into the vehicle to steal it by the time when a user who possesses a regular key (hereinafter referred to as an “authorized user”) comes to the vehicle after starting the engine from a remote location by a remote operation.

In spite of such a risk, the authorized user feels it inconvenient to restart the engine when getting in the vehicle although the vehicle engine was once remotely started by the remote control.

In order to eliminate the inconvenience, when a user gets in the vehicle after starting the vehicle engine remotely and when a result of an authentication is successful based on a key code obtained from a user key by radio, the starting apparatus maintains the running of the vehicle engine. When the result of the authentication is unsuccessful, the starting apparatus stops the running of the engine in the vehicle. In this way, the starting apparatus eliminates the foregoing risks and inconvenience. Such a technology is disclosed in Japanese Patent Laid Open Publication No. JP 2006-248471 A.

However, the suggested technology might impair the safety on the running vehicle. Specifically, the starting apparatus installed in the vehicle may need a fixed time to obtain the result of the authentication.

In addition, in the starting apparatus, the result of the authentication may become unsuccessful due to noise effects or so when the starting apparatus obtains the key code from the regular key by radio.

Further, the user may run the vehicle before obtaining the result of the authentication because the vehicle engine is already running.

When these cases occur at the same time, there is a risk that safety on the running vehicle might be impaired because the starting apparatus stops the running of the engine based on the unsuccessful result of the authentication that is obtained while the vehicle is running.

Therefore, in order to eliminate risks of the vehicle being stolen and the inconvenience as well as to improve safety on the running, when a user unlocks the vehicle door and gets in the vehicle after starting the vehicle engine remotely, it is conceivable to maintain the engine running as an authorized use despite the result of authentication.

However, there is a problem that the vehicle can be easily stolen when the remote control is stolen because it is relatively easy to fraudulently unlock the vehicle door.

### SUMMARY OF THE INVENTION

According to one aspect of the invention, an engine starting apparatus for starting an engine that is installed in a vehicle includes a starting part that starts the engine in response to radio signals received from a remote control; an obtaining part that obtains a result of an authentication by an authentication part that authenticates a key code stored in a vehicle key that a user possesses; a detector that detects whether a door of the vehicle is opened; a memory part that stores unsuccessful data indicating that the result of the authentication was unsuccessful while maintaining the engine running when the result of the authentication implemented after the start of the engine by the starting part is unsuccessful; and a stopping part that stops the running of the engine when the door is detected to be opened after the start of the engine by the starting part if the unsuccessful data are stored in the memory part before the start of the engine by the starting part.

When an authorized user starts the engine remotely and gets in the vehicle, the engine starting apparatus does not stop the running of the engine. In addition, the engine starting apparatus can prevent the vehicle from being stolen by a non-authorized user who has stolen a remote control.

According to another aspect of the invention, the engine starting apparatus further includes a deleting part that deletes the unsuccessful data from the memory part when the result of the authentication is successful.

The starting apparatus allows the user to start the engine remotely after the result of the authentication is successful. That is, the starting apparatus allows the authorized user to use the vehicle.

Therefore, it is an object of the present invention, when the user uses the vehicle that allows the remote control to start the engine, to provide technique that eliminates the risk of the vehicle being stolen and inconvenience as well as to ensure the safety on the running vehicle.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 shows a drawing of a vehicle.

FIG. 2 shows a drawing to explain a vehicle system.

FIG. 3 shows a drawing to explain a system of a starting apparatus.

FIG. 4 is a time chart to explain control.

FIG. 5 is a time chart to explain control.

FIG. 6 is a flow chart to explain control.

### DESCRIPTION OF THE EMBODIMENTS

The engine starting system in Typical Embodiment of the invention is described referring to the attached drawings.

### Typical Embodiment

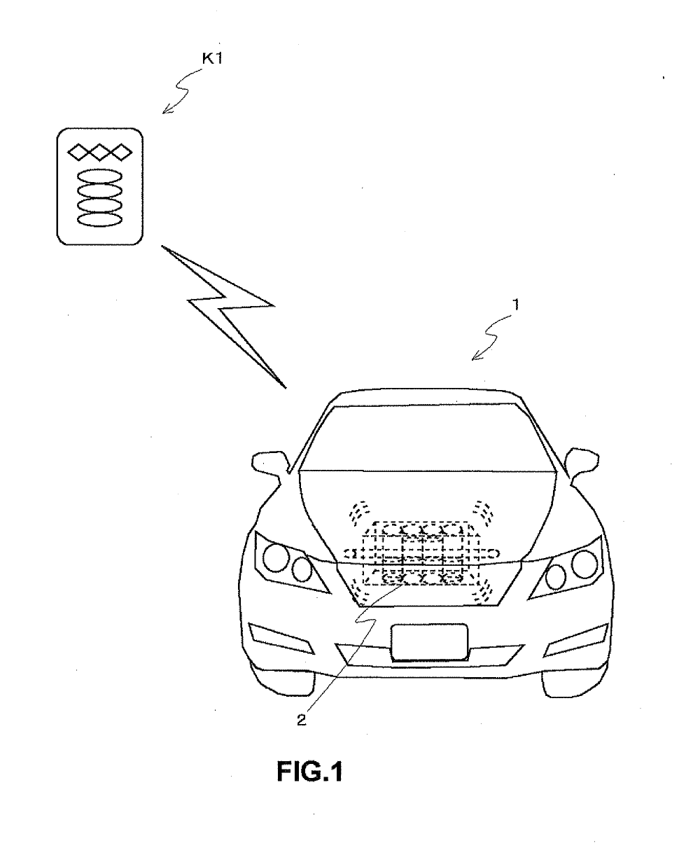

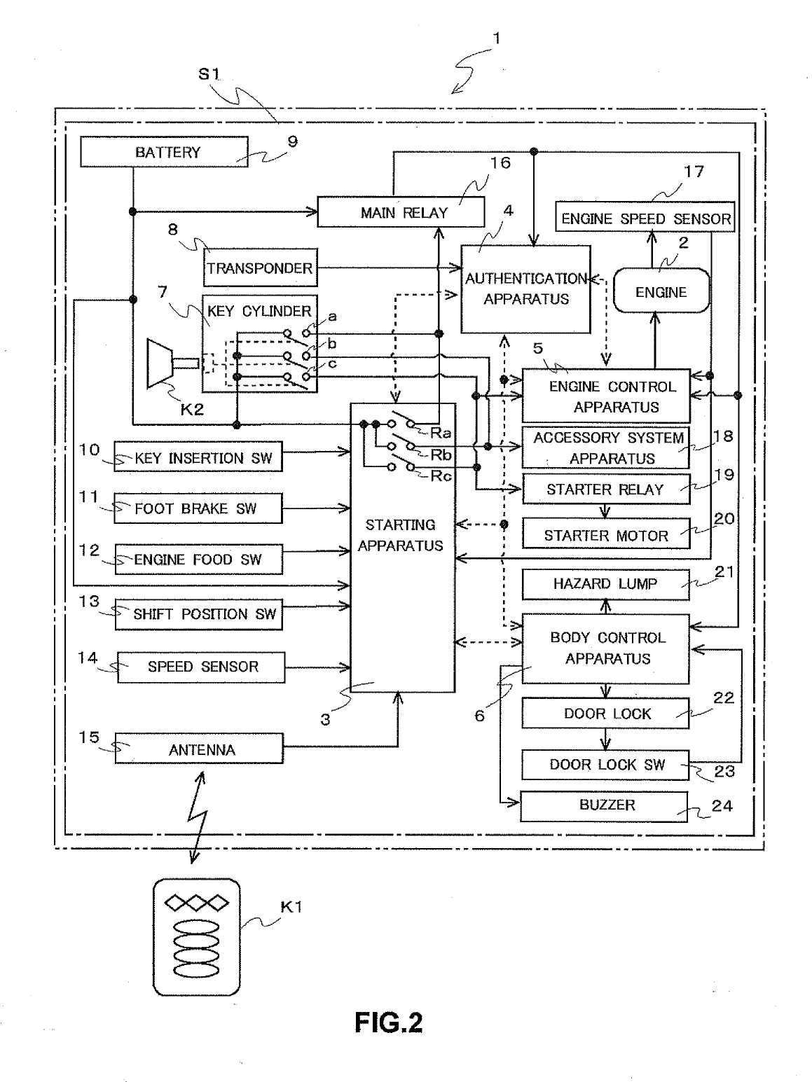

A system to start an engine installed in a vehicle remotely by instruction from a remote control is described based on FIGS. 1 and 2.

First, a user who possesses a regular key of a vehicle 1 is defined as an authorized user of the vehicle 1 and the user who uses the vehicle 1 fraudulently without possessing the regular key is defined as a non-authorized user. The authorized user shall possess a remote control K1 to start an engine 2 of the vehicle 1 remotely.

As shown in FIG. 1, the authorized user operates a starting button of the remote control K1. The remote control K1 accepts the operation and sends starting signals to a starting apparatus 3 installed in the vehicle 1 via radio communication. The starting apparatus 3 starts the engine 2 installed in the vehicle 1 based on starting signals received via radio communication.

(System)

A system included in the vehicle 1 is described based on FIG. 2.

The vehicle 1 includes a system S1 having elements to fulfill various functions to start the engine 2.

The system S1 includes the engine 2, the starting apparatus 3, an authentication apparatus 4, an engine control apparatus 5, a body control apparatus 6, a key cylinder 7, a transponder 8, a battery 9, a key insertion switch 10, a foot brake switch 11, an engine food switch 12, a shift position switch 13, a speed sensor 14, an antenna 15, a main relay 16, an engine speed sensor 17, an accessory system apparatus 18, a starter relay 19, a starter motor 20, a hazard lump 21, a door lock 22, a door lock switch 23 and a buzzer 24 and the like. Further, the remote control K1 and a regular key K2, the key of the vehicle, are attached to the system S1.

In addition, these elements are directly connected by communication lines and electronic power lines or by an in-vehicle network. Thus, these elements can send or receive various signals.

The system S1 fulfills various functions, mainly, a function of starting engine normally (hereinafter referred to as a “first engine starting”), a function of engine starting based on a remote control (hereinafter referred to as a “second engine starting”) and an authentication function to fulfill a key authentication at a start-up and the like.

Under a composition of the system S1, the authorized user inserts the regular key K2 into a key slot of the key cylinder 7 and turns the key, thereby turning on a first ACC switch a, a first ignition switch b, a first starter switch c in series. Therefore, when the user turns the regular key K2 to a position where the first ACC switch a is turned on, accessories like audios and air conditioner control apparatus can be activated. In addition, when the user turns the regular key K2 to a position where the first ignition switch b is turned on, the main relay is turned on, so that the engine control apparatus 5 and the body control apparatus 6 and the like can be activated.

In addition, the starting apparatus 3 is constantly powered on and in operation even if the first ignition switch b is not turned on. Or only elements that communicate with the remote control K1 are constantly powered on and the starting apparatus 3 starts up other elements when communicating.

(First Engine Starting Function)

The first engine starting function is implemented mainly by the regular key K2, the key cylinder 7, the starter relay 19, the starter motor 20, the engine 2, and the engine control apparatus 5 and the like.

The first engine starting is described. The authorized user inserts the regular key K2 into a key slot and turns to a position where the first starter switch c is turned on. Turning on the first starter switch c turns the battery 9 and the starter relay 19 on, so that the starter motor 20 is powered on and driven. That is, the authorized user can drive the starter motor 20 by operating the regular key K2 to turn on the first starter switch c.

Accordingly, the authorized user judges that the rotation speed of the engine 2 has reached the predetermined one (for example 1500 rpm) based on engine sound and the like and then stops the operation, so that the first engine starting is implemented.

On the other hand, when the engine control apparatus 5 receives starter switch signals, it makes the engine 2 run by controlling ignition plugs and injectors included in the engine 2. The engine control apparatus 5 receives assistance from a starter motor until the rotation speed of the engine 2 reaches the predetermined one that are measured based on received signals from the engine speed sensor 17. The apparatus 5 implements control so that it can keep the predetermined rotation speed of the engine 2 when it reaches the predetermined one. That is, the engine control apparatus 5 keeps the engine 2 in idling condition.

In addition, the engine control apparatus includes a non-volatile memory part that stores the first engine starting program and the like, a control part that runs the program, a volatile memory part that serves as a working area when the program is run and an interface to communicate with external elements and the like.

(Authentication Function)

The authentication function is implemented mainly by the regular key K2, the transponder 8, the authentication apparatus 4 and the engine control apparatus 5 and the like.

The authentication function is described. When the authorized user inserts the regular key K2 into the key slot, the transponder 8 receives a key code stored in the regular key K2 via radio communication. The transponder 8 sends the received key code to the authentication apparatus 4. The authentication apparatus 4 judges whether the received key code is the same as the key code stored in advance. The authentication apparatus 4 sends data indicating the authentication result is successful to the engine control apparatus 5 if they are the same. If they are not the same, the authentication apparatus 4 sends data indicating the authentication result is unsuccessful to the engine control apparatus 5. The engine control apparatus 5 implements the first engine starting when it receives starter switch signals and data indicating the success of the authentication result from the authentication apparatus 4.

In addition, the authentication apparatus 4 includes a non-volatile memory part that stores authentication program and the like, a control part that runs the program, a volatile memory part that serves as working areas when the program is run, and an interface to communicate with external elements and the like.

(Second Engine Starting Function)

The second engine starting function is implemented mainly by the remote control K1, the antenna 15, the starting apparatus 3, the starter relay 19, the starter motor 20 and the engine control apparatus 5 and the like.

The second engine starting function is described. When the authorized user operates an engine starting button of the remote control K1, the remote control K1 sends starting signals to the starting apparatus 3 installed in the vehicle 1 via radio communication. The starting apparatus 3 makes the engine 2 start based on starting signals received via the radio communication through the antenna 15. At the start-up, the starting apparatus 3 turns on a second ACC switch Ra, a second ignition switch Rb and a second starter switch Rc that the apparatus includes itself after judging that the apparatus 3 has received the starting signals and that the condition of the vehicle can be warmed up, thereby turning on the starter relay 19, driving the starter motor 20 and starting the engine 2 along with the engine control apparatus 5.

The system S1 includes two modes, a normal mode and a run on mode. A user can select each mode by the remote control K1 and by a switch included in the vehicle. The detail of these modes is described.

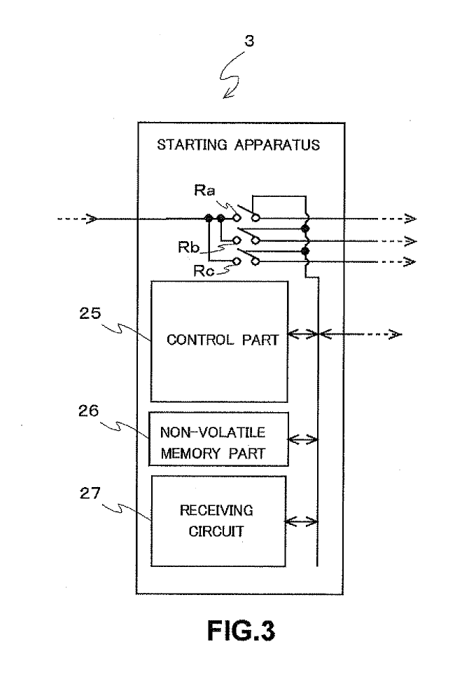

In addition, the starting apparatus 3, as shown in FIG. 3, includes a non-volatile memory part 26 that stores program and the like, a control part 25 that runs the program, a volatile memory part that serves as working areas when the program is run, a receiving circuit 27 that controls receiving signals from the antenna 15 and an interface to communicate with external elements and the like.

(Normal Mode)

The normal mode is described. When a user unlocks the door lock 22 to get in the vehicle 1 after starting the engine 2 remotely, the starting apparatus 3 stops the running of the engine 2.

The normal mode is described in more detail. When the user unlocks the door to open it after starting the engine 2 remotely by remote control K1, the door lock 22 is unlocked. The door lock switch 23 that detects the door lock 22 is unlocked sends signals indicating the door is unlocked to the body control apparatus 6. When the body control apparatus 6 receives signals indicating that the door is unlocked and signals indicating that the engine 2 is remotely started, signals indicating the stop of the running of the engine 2 are sent to the engine control apparatus 5. Thus, the engine control apparatus 5 stops the running of the engine 2.

(Run on Mode)

The run on mode is described. When the authorized user unlocks the door lock 22, gets in the vehicle 1 and inserts the regular key K2 after starting the engine 2 remotely by the operation of the remote control K1, the starting apparatus 3 maintains the engine 2 running.

When the non-authorized user unlocks the door lock 22, gets in the vehicle 1 after starting the engine 2 remotely by the operation of the remote control K1 that has been stolen from the authorized user, the starting apparatus 3 also maintains the engine 2 running.

In addition, when the non-authorized user inserts the irregular key K2X into the key cylinder 7 and its key authentication is unsuccessful, the starting apparatus 3 maintains the engine 2 running. However, subsequently, when the engine 2 is remotely started by the remote control K1 and then the door lock 22 is unlocked, the starting apparatus 3 stops the running of the engine.

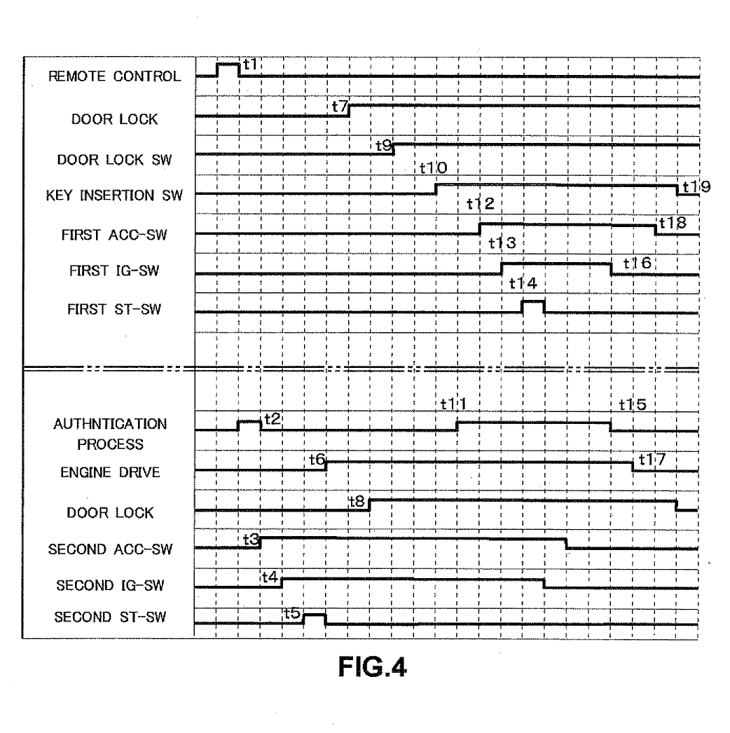

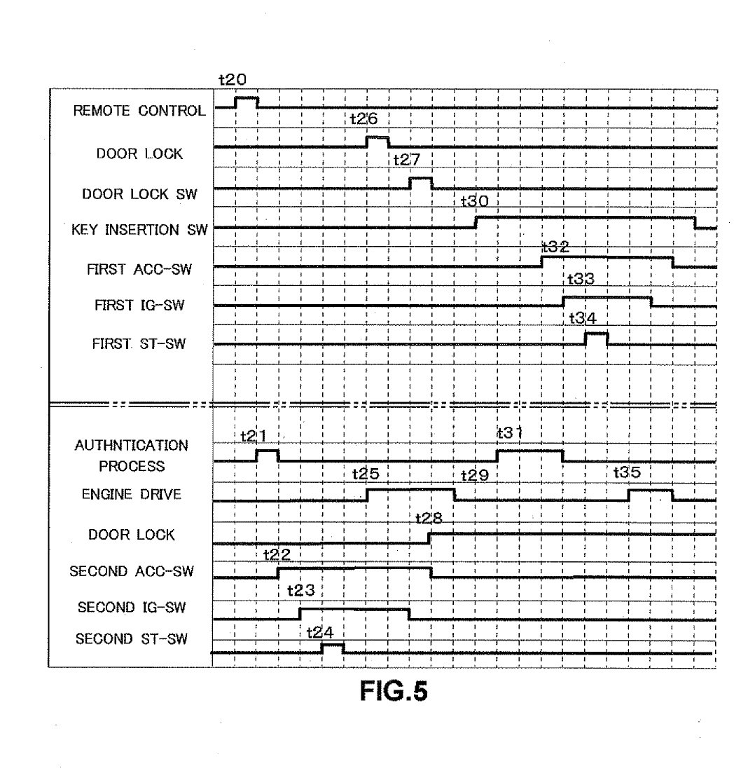

The control timing of the run on mode is described in detail based on time charts of FIG. 4 and FIG. 5. In addition, in order to simply describe the significance of the technology, the run on mode described in FIG. 4 and FIG. 5 adopts the case where the authorized user uses the vehicle 1 that is temporarily stolen by the non-authorized user and returned to the authorized user.

(Control Process/Time Chart)

First, at a timing t1 shown in FIG. 4, the non-authorized user starts the engine 2 of the vehicle 1 remotely by the remote control K1 that has been stolen from the authorized user.

Next, at a timing t2, having received the signals to start the engine from the remote control K1, the starting apparatus 3 sends a pseudo key code to the authentication apparatus 4. The apparatus 4 implements the authentication process based on the pseudo key code by the authentication function. The apparatus 4 sends data indicating the success of the authentication result to the engine control apparatus 5 and the starting apparatus 3.

Next, at a timing t3, having received data indicating the success of the authentication result from the authentication apparatus 4, the starting apparatus 3 turns on the second ACC switch Ra that the apparatus 3 includes itself, thereby providing electric power supplied from the battery 9 to activate the accessory system apparatus 18.

Next, at a timing t4, the starting apparatus 3 turns on the second ignition switch Rb that the apparatus 3 includes itself, thereby providing electric power supplied from the battery 9 to activate plural of control apparatus.

Next, at a timing t5, the starting apparatus 3 turns on the second starter switch Rc that the apparatus 3 includes itself, thereby turning on the starter relay 19 to drive the starter motor 20. That is, the starting apparatus 3 starts the engine 2. In addition, the starting apparatus 3 sends ON signal of the second starter switch Rc to the engine control apparatus 5.

Next, at a timing t6, having received the ON signal of the second starter switch Rc, the engine control apparatus 5 starts the engine 2 and keeps it in the idling condition.

Next, at a timing t7, the non-authorized user fraudulently unlocks the door of the vehicle 1.

Next, at a timing t8, the door lock 22 of the vehicle 1 is unlocked. That is, the non-authorized user gets in the vehicle 1.

Next, at a timing t9, by unlocking the door lock 22 of the vehicle 1, signals of the door lock switch 23 turns to ON meaning that the door lock 22 is unlocked.

Next, at a timing t10, when the non-authorized user inserts the irregular key K2X into the key cylinder 7 after getting into the vehicle 1, the signals of the key insertion switch 10 turn to ON. When the irregular key K2X is inserted into the key cylinder 7, the key sends a key code, which is stored in a non-volatile memory part that the irregular key K2X includes itself, to the transponder 8 via radio communication. Further, the transponder 8 sends the received key code to the authentication apparatus 4.

Next, at a timing t11, having received the key code from the transponder 8, the authentication apparatus 4 implements the authentication process based on the key code by the authentication function. The authentication process implemented by the apparatus 4 judges whether or not the key code coincides with a code stored in the non-volatile memory part 26 that the apparatus 4 stores in advance. The apparatus 4 judges that the authentication result is successful when both codes are the same. When the apparatus 4 doesn't judge that the codes are the same, it repeats the judgment a predetermined number of times. After repeating the judgment the predetermined number of times, when the apparatus 4 has never judged that the codes are the same, the authentication results in unsuccessful. Accordingly, the apparatus 4 requires a fixed time (for example, 10 seconds) at most for the process when the authentication result is unsuccessful.

At a timing t11, the authentication apparatus 4 starts an authentication judgment. At a timing t15, the apparatus 4 completes the authentication judgment. The authentication result that the apparatus 4 judges in this case is unsuccessful, so that the data indicating the authentication result is unsuccessful are sent to the engine control apparatus 5 and the starting apparatus 3. The starting apparatus 3 obtains data indicating the authentication result is unsuccessful and stores data indicating the authentication result was unsuccessful in the non-volatile memory part 26.

Next, at a timing t12, the non-authorized user turns the inserted irregular key K2X to a position where the first ACC switch a is turned on, whereby the accessory system apparatus 18 can be activated by electric power supplied from the battery 9.

Next, at a timing t13, the non-authorized user turns the inserted irregular key K2X to a position where the first ignition switch b is turned on, whereby control devices and the like can be activated by electric power supplied from the battery 9.

Next, at a timing t14, the non-authorized user turns the inserted irregular key K2X to a position where the first starter switch c is turned on, thereby making the starter relay 19 be turned on, the starter motor 20 be driven and the engine 2 start. ON signal of the first starter switch c is sent to the engine control apparatus 5. The apparatus 5 receiving the ON signal of the first starter switch c makes the engine 2 start and keeps it in the idling condition.

In this way, in the run on mode, in order to maintain the engine 2 running that the user has started remotely after getting into the vehicle, the user needs to insert the key into the key cylinder 7 to turn on the first starter switch c. This is because the authentication process needs to be implemented by the authentication apparatus 4 and further the first ignition switch b needs to be turned off to stop the engine 2 later. Therefore, the user needs to turn the key to a position in advance where the first ignition switch b can be turned off.

As described above, there is a case where the authentication apparatus 4 takes a fixed amount of time to obtain the result of the authentication after starting of the authentication process. With regard to this case, the authentication apparatus 4 takes a fixed time between timing t11 and timing t15 to complete the authentication process. The system S1 has already started and run the engine 2 at the timing t6, so that there is a case where the non-authorized user drives the vehicle 1 during the time. In such a case, the engine control apparatus 5 maintains the engine 2 running because safety on the running vehicle 1 is impaired if the running of the engine 2 is stopped when the authentication result by the authentication apparatus 4 is unsuccessful.

Next, at a timing t16, the non-authorized user operates the irregular key K2X and then turns off the first ignition switch b.

Next, at a timing t17, when the first ignition switch b is turned off by the non-authorized user, the engine control apparatus 5 receiving the signals stops the running of the engine 2. The system S1 turns off the main relay 16 according to the OFF signal, whereby electronic power supply, from the battery 9 to each control apparatus and the like, is shut off to complete the function.

Next, at a timing t18, the non-authorized user operates the irregular key K2X and turns off the first ACC switch a, whereby electronic power to the accessory system apparatus 18 is shut off to complete the function.

Next, at a timing t19, the non-authorized user removes the irregular key K2X from the key cylinder 7, whereby signals at the key insertion switch 10 indicate the state of OFF that means no key is inserted.

Next, at a timing t20 shown in FIG. 5, the non-authorized user starts the engine 2 of the vehicle 1 remotely by the remote control K1 that has been stolen.

Next, at a timing t21, having received the signals to start the engine from the remote control K1, the starting apparatus 3 sends a pseudo key code to the authentication apparatus 4. The apparatus 4 implements the authentication process based on the pseudo key code by the authentication function and sends data indicating the success of the authentication result to the engine control apparatus 5 and the starting apparatus 3.

Next, at a timing t22, the starting apparatus 3 that receives data indicating the success of the authentication result from the authentication apparatus 4 turns on the second ACC switch Ra that the apparatus 3 includes itself, thereby providing electric power to activate the accessory system apparatus 18.

Next, at a timing t23, the starting apparatus 3 turns on the second ignition switch Rb that the apparatus 3 includes itself, thereby providing electric power to activate each control apparatus and the like.

Next, at a timing t24, the starting apparatus 3 turns on the second starter switch Rc that the apparatus includes itself, thereby turning on the starter relay 19 to drive the starter motor 20. That is, the starting apparatus 3 starts the engine 2. In addition, the starting apparatus 3 sends ON signal of the second starter switch Rc to the engine control apparatus 5.

Next, at a timing t25, having received the ON signal of the second starter switch Rc, the engine control apparatus 5 makes the engine 2 start and keeps it in the idling condition.

Next, at a timing t26, the non-authorized user fraudulently unlocks the door of the vehicle 1.

Next, at a timing t27, the door lock 22 of the vehicle 1 is unlocked. That is, the non-authorized user gets in the vehicle 1.

Next, at a timing t28, by unlocking the door lock 22 of the vehicle 1, signals of the door lock switch 23 turn to ON meaning that the door lock 22 is unlocked. Having received the ON signal indicating the door lock is unlocked, the body control apparatus 6 sends the signals indicating the door lock is unlocked to the starting apparatus 3.

Next, at a timing t29, when the starting apparatus 3 receives signals indicating the door lock is unlocked and when data indicating the authentication result is unsuccessful are stored in the non-volatile memory part 26 the apparatus 3 includes itself, the apparatus 3 sends signals to stop the running of the engine 2 to the engine control apparatus 5. The engine control apparatus 5 that has received signals to stop the running of the engine 2 stops the running of the engine 2.

This causes a risk that the vehicle 1 may be temporarily stolen by the non-authorized user who has stolen the remote control. However, as the running of the engine 2 which has been remotely started is stopped later, the vehicle can not run. Further, the non-authorized user doesn't possess the regular key, so that the non-authorized user can not start the engine normally to run the vehicle 1 unless the non-authorized user steals the regular key or makes a fraudulent copy. That is, the vehicle 1 has the risk to be stolen temporally; however, the running becomes impossible in the end. Therefore, the non-authorized user's willingness to steal the vehicle can be diminished. The authorized user is allowed to use the run-on mode, so that inconvenience of having to restart the engine 2 after remotely starting it can be eliminated.

Next, at a timing t30, when the authorized user inserts the regular key K2 into the key cylinder 7 after taking back the vehicle 1 and getting in the vehicle 1, the signals of the key insertion switch 10 is turned to ON. When the regular key K2 is inserted into the key cylinder 7, the key K2 sends a key code, which is stored in a non-volatile memory part that the regular key K2 includes itself, to the transponder 8 via radio communication. Further, the transponder 8 sends the received key code to the authentication apparatus 4.

Next, at a timing t31, the authentication apparatus 4 receiving the key code from the transponder 8 implements the authentication process based on the key code by the authentication function. The authentication result in this case results in success because the authentication is based on the key code of the regular key K2 that the authorized user possesses.

The authentication apparatus 4 sends data indicating the success of the authentication to the starting apparatus 3. The starting apparatus 3 obtains data indicating the success and deletes data indicating the unsuccess, which is stored in the non-volatile memory part 26.

That is, the authorized user who has taken back the vehicle 1 starts the engine 2 of the vehicle 1 by the operation of the regular key K2, which cancels the order to stop the running of the engine 2 when it is started remotely next time. Therefore, the regular run on mode can be utilized at the remote engine starter.

Next, at a timing t32, the authorized user turns the inserted regular key K2 to a position where the first ACC switch is turned on, thereby activating the accessory system apparatus 18 with electric power supplied from the battery 9.

Next, at a timing t33, the authorized user turns on the first ignition switch b, thereby activating each control apparatus with electric power supplied.

Next, at a timing t34, the authorized user turns the inserted regular key K2 to a position where the first starter switch c is turned on, thereby making the starter relay 19 be turned on, the starter motor 20 be driven and the engine 2 start. The ON signal of the first starter switch c is sent to the engine control apparatus 5. The apparatus 5 receiving the ON signal of the first starter switch c makes the engine 2 start and keeps it in the idling condition.

The following procedure to stop the running of the engine 2 of the vehicle 1 is omitted because it is the same as the one that is described before.

(Control Process/Flow Chart)

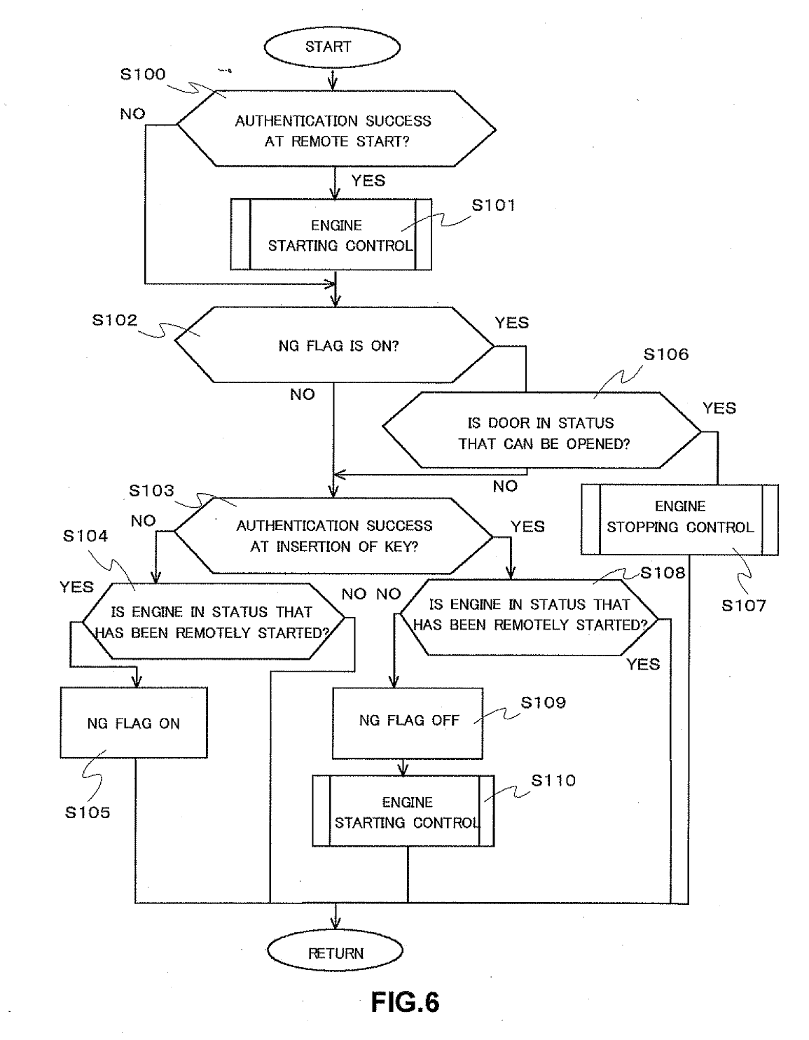

A control procedure in the run on mode is described based on FIG. 6 in detail. The control shown in FIG. 6 is implemented in predetermined cycles from an activating to a stopping of the system S1 of the vehicle 1.

At a step S100, the authentication apparatus 4 judges whether the authentication implemented by the authentication function is successful or not when the engine is remotely started. If the authentication result is successful, (if YES at the step S100), the step shifts to a step S101. If the authentication result is unsuccessful (If NO at the step S100), the step shifts to a step S102.

At the step S101, the starting apparatus 3 and the engine control apparatus 5 start the engine 2 as described above. The engine control apparatus 5 makes the engine 2 start and keeps it in the idling condition. Then the step shifts to the step S102.

The authentication function that the authentication apparatus 4 includes is specifically described. The starting apparatus 3 receiving signals to start the engine 2 from the remote control K1 sends the pseudo key code to the authentication apparatus 4. The apparatus 4 implements the authentication process based on the pseudo key code by the authentication function and sends data indicating the success of the authentication result to the engine control apparatus 5 and the starting apparatus 3.

At the step S102, the starting apparatus 3 in the system S1 judges whether NG flag, which is stored in the non-volatile memory part 26 that the apparatus 3 includes itself, is on or not. When the NG flag is not on (if NO at the step S102), the step shifts to a step S103 and when the NG flag is on (if YES at the step S102), the step shifts to a step S106. When the system S1 is installed in the vehicle 1, that is, when the vehicle 1 is shipped, NG flag is set to OFF.

At the step S103, when the key is inserted into the key cylinder 7, the authentication apparatus 4 authenticates whether the key is regular or not. If the key is regular, the authentication result is judged to be successful, and if the key is not regular, the authentication result is judged to be unsuccessful. If the authentication result is judged to be unsuccessful (if NO at the step S103), the step shifts to a step S104. If the authentication result is judged to be successful (if YES at the step S103), the step shifts to S108.

The authentication function that the authentication apparatus 4 includes is specifically described. When the key is inserted into the key cylinder 7, the key code, which is stored in the non-volatile memory part that the key includes itself, is sent to the transponder 8 via radio communication. The transponder 8 sends the received key code to the authentication apparatus 4. The authentication apparatus 4 judges whether the received key code from the transponder 8 is the same as the key code stored in the non-volatile memory part in advance. The authentication apparatus 4 judges the authentication result is successful if they are the same. If the authentication apparatus 4 doesn't judge they are the same, the judgment is repeated a predetermined number of times. After repeating the judgment a predetermined number of times, when the authentication apparatus 4 doesn't judge they are the same even once, the apparatus 4 doesn't judge that the authentication result is successful. That is, the apparatus 4 judges the authentication result is unsuccessful in that case. When the authentication apparatus 4 judges that the authentication result is successful, data indicating the success are sent to the starting apparatus 3 and the engine control apparatus 5. When the authentication apparatus 4 judges that the authentication is unsuccessful, data indicating the unsuccess are sent to the starting apparatus 3 and the engine control apparatus 5.

At the step S104, the starting apparatus 3 judges whether or not the engine 2 is in a state that has been remotely started. When the apparatus 3 judges it is in the state (if YES at the step S104), the step shifts to a step S105. If the apparatus 3 doesn't judge it is in the state (if NO at the step S104), the step shifts to Return.

At the step S105, the starting apparatus 3 sets NG flag that is set in the non-volatile memory part 26 that the apparatus 3 includes itself to be on while maintaining the engine 2 running. That is, the starting apparatus 3 stores data indicating the authentication result was unsuccessful in the non-volatile memory part 26, while maintaining the engine 2 running.

In other words, at the step S103, when the authentication result is unsuccessful at the insertion of the key and when the engine 2 is remotely started, the starting apparatus 3 maintains the engine 2 running without being stopped even if the authentication result is unsuccessful. Then the starting apparatus 3 sets the NG flag to be on so that the running of the engine 2 is stopped when the door of the vehicle 1 is locked next time.

At the step S106, when a user unlocks the door of the vehicle 1, the door lock is unlocked and the door is in a status that can be opened, the body control apparatus 6 receives signals indicating that the door is in a status that can be opened from the door lock switch 23. The body control apparatus 6 sends the signals to the starting apparatus 3.

The starting apparatus 3 judges whether the apparatus 3 has received the signals or not, that is, the apparatus 3 judges (detects) whether or not the door of the vehicle 1 is in a state that can be opened. If the apparatus 3 judges that the door of the vehicle 1 is in the state (if YES at the step S106), the step shifts to a step S107, and if the apparatus 3 doesn't judge that the door of the vehicle 1 is in the state (if NO at the step S106), the step shifts to the step S103.

At the step S107, the starting apparatus 3 sends signals to stop the running of the engine 2 to the engine control apparatus 5. The engine control apparatus 5 receiving signals to stop the running of the engine 2 stops the running of the engine 2.

This causes a risk that the vehicle 1 may be temporarily stolen by the non-authorized user who has stolen the remote control. However, as the running of the engine 2 which has been remotely started is stopped later, the vehicle can not run. Further, the non-authorized user doesn't possess the regular key so that the user can not start the engine normally to run the vehicle 1. That is, the vehicle 1 has the risk to be stolen temporally; however, the running becomes impossible in the end. Therefore, the non-authorized user's willingness to steal the vehicle can be diminished. The authorized user is allowed to use the run-on mode, so that inconvenience of having to restart the engine 2 after remotely starting it can be eliminated.

At the step S108, the starting apparatus 3 judges whether or not the engine 2 is in a state that has been remotely started. When the apparatus 3 judges that the engine 2 is in the state, (if YES at the step S108), it shifts to RETURN, if the apparatus 3 doesn't judge that the engine 2 is in the state (if NO at the step S108), the step shifts to a step S109.

At the step S109, the starting apparatus 3 sets the NG flag that is set in the non-volatile memory part 26 that the apparatus 3 includes itself to be OFF. Then the step shifts to a step S110.

At the step S108, the engine control apparatus 5 receives data indicating the success of the authentication result from the authentication apparatus 4, so that the apparatus 5 makes the engine 2 start and keeps it in the state of idling while receiving assistance through the drive of the starter motor 20 that is driven by user's operation of the regular key K2.

That is, when the authentication result from the authorized user's operation of the regular key K2 is successful, the regular start of the engine is implemented as well as NG flag indicating whether the running of the engine after being started remotely is maintained or not is set to be OFF, thereby allowing the authorized use of the vehicle 1 by the authorized user.

Accordingly, NG flag is set to on when the vehicle 1 is fraudulently used by the non-authorized user, and the flag is data to stop the running of the engine 2 when it is remotely started next time. NG flag is set to OFF when the vehicle 1 is duly used by the authorized user, and the flag is data to maintain the engine 2 running when and after it is remotely started next time.

The system S1 implements the foregoing control, whereby the vehicle 1 can not run because the running of the engine 2 which has been remotely started is stopped later, although the vehicle can be temporarily stolen by the non-authorized user who has stolen the remote control.

Further, the non-authorized user doesn't possess the regular key so that the user can not start the engine normally to run the vehicle 1 unless the non-authorized user steals the regular key or makes a fraudulent copy. That is, the vehicle 1 has a risk to be stolen temporally; however, the running becomes impossible in the end. Therefore, the non-authorized user's willingness to steal the vehicle can be diminished. The authorized user is allowed to use the run-on mode, so that inconvenience of having to restart the engine 2 after remotely starting it can be eliminated.

### Alternative Embodiment

One embodiment of the invention has been described so far. The invention is not limited to the above embodiment but it is possible to be applied to various embodiments. Other embodiments are described below. The embodiments described below, of course, can be mixed properly.

### Alternative Embodiment 1

The first engine starting function in the above typical embodiment is described like “The authentication apparatus 4 receives the key code that is stored in the key via the transponder 8 when the key is inserted in the key cylinder 7. The authentication apparatus 4 implements the authentication of the key code received from the transponder 8”. However, a so called smart entry system can be applied. In the smart entry system, a portable entry apparatus sends a key code to a body control apparatus 6 via radio communication, the apparatus 6 further sends a key code to an authentication apparatus 4 and the apparatus 4 implements the foregoing authentication based on the key code.

The authentication apparatus 4 sends the authentication result to the body control apparatus 6 and an engine control apparatus 5. When the authentication result is successful, the apparatus 6 unlocks the door, and when the authentication result is unsuccessful, the apparatus 6 keeps the door locked. When the authorized user implements an operation of starting an engine 2 and when the authentication result is successful, the apparatus 5 starts the engine. When the user implements the operation and also when the authentication result is unsuccessful, the apparatus 5 prevents the start of the engine 2.

The starting operation is implemented by user's operation of a push button at a push-type engine starting apparatus, which is included in a system S1 instead of a key cylinder. The push-type engine starting apparatus implements an ACC function, an ignition function and a starter function according to the number of times of pushing and the pushing time.

This allows similar effects as the typical embodiment to be obtained.

### Alternative Embodiment 2

At the timing t28 and the timing t29 at (Control process/Time chart) and at the step S106 and the step S107 at (Control process/Flow chart) in the above typical embodiment, it has been described like “When the starting apparatus 3 receives signals indicating the door lock is unlocked via the body control apparatus 6 and when data indicating the authentication result is unsuccessful are stored in the non-volatile memory part 26 that the apparatus 3 includes itself, the apparatus 3 sends signals to stop the running of the engine 2 to the engine control apparatus 5. The engine control apparatus 5 that has received signals to stop the running of the engine 2 stops the running of the engine 2”. However, it can be configured as follows; a body control apparatus 6 stores data indicating an authentication result is unsuccessful in a non-volatile memory part the apparatus 6 includes itself. When the apparatus 6 stores data indicating that the authentication result is unsuccessful in the non-volatile memory part and receives signals indicating the authentication result is unsuccessful, the apparatus 6 sends signals to stop the running of an engine 2 to an engine control apparatus 5 and the apparatus 5 receiving the signals to stop the running of the engine 2 stops the running of the engine 2.

This allows similar effects as the typical embodiment to be obtained.

The above embodiments describe that the functions are implemented by a software process performed by a CPU operation according to programs; however, a part of the functions may be implemented by using an electrical hardware circuit. On the other hand, a part of the functions that are implemented by hardware circuit may be implemented by using software.

While the invention has been shown and described in detail, the foregoing description is in all aspects illustrative and not restrictive. It is therefore understood that numerous other modifications and variations can be devised without departing from the scope of the invention.

What is claimed is:

1. An engine starting apparatus for starting an engine that is installed in a vehicle, the apparatus comprising:
a starting part that starts the engine in response to radio signals received from a remote control;
an obtaining part that obtains a result of an authentication by an authentication part that authenticates a key code stored in a vehicle key that a user possesses;
a detector that detects whether a door of the vehicle is opened;
a memory part that stores unsuccessful data indicating that the result of the authentication was unsuccessful while maintaining the engine running when the result of the authentication implemented after the start of the engine by the starting part is unsuccessful; and
a stopping part that stops the running of the engine when the door is detected to be opened after the start of the engine by the starting part if the unsuccessful data are stored in the memory part before the start of the engine by the starting part.

2. The engine starting apparatus according to claim 1, wherein
the apparatus further includes a deleting part that deletes the unsuccessful data from the memory part when the result of the authentication is successful.

3. An engine starting method that starts an engine installed in a vehicle, the method comprising the steps of
(a) starting the engine in response to radio signals received from a remote control;
(b) obtaining a result of an authentication by an authentication part that authenticates a key code stored in a vehicle key that a user possesses;
(c) detecting whether a door of the vehicle is opened;
(d) maintaining the engine running when the result of the authentication implemented after the start of the engine by the step (a) is unsuccessful;
(e) storing unsuccessful data indicating that the result of the authentication was unsuccessful in a memory part when the result of the authentication implemented after the start of the engine by the step (a) is unsuccessful; and
(f) stopping the running of the engine when the door is detected to be opened after the start of the engine by the step (a) if the unsuccessful data are stored in the memory part before the start of the engine by the step (a).

4. The engine starting method according to claim 3, the method further comprises the step of:
(g) deleting the unsuccessful data from the memory part when the result of the authentication is successful.
